(19) United States
(12) Patent Application Publication
(10) Pub. No.: US 2013/0252004 A1
(43) Pub. Date: Sep. 26, 2013

(54) RARE EARTH-IRON-NITROGEN-BASED ALLOY MATERIAL, METHOD FOR PRODUCING RARE EARTH-IRON-NITROGEN-BASED ALLOY MATERIAL, RARE EARTH-IRON-BASED ALLOY MATERIAL, AND METHOD FOR PRODUCING RARE EARTH-IRON-BASED ALLOY MATERIAL

(71) Applicants: Toru Maeda, Itami-shi (JP); Asako Watanabe, Itami-shi (JP); Motoi Nagasawa, Itami-shi (JP); Takeshi Kato, Osaka-shi (JP)

(72) Inventors: Toru Maeda, Itami-shi (JP); Asako Watanabe, Itami-shi (JP); Motoi Nagasawa, Itami-shi (JP); Takeshi Kato, Osaka-shi (JP)

(73) Assignee: SUMITOMO ELECTRIC INDUSTRIES, LTD., Osaka-shi, Osaka (JP)

(21) Appl. No.: 13/824,553

(22) PCT Filed: May 22, 2012
(86) PCT No.: PCT/JP12/63045

§ 371 Date: Mar. 18, 2013

(30) Foreign Application Priority Data
May 24, 2011 (JP) 2011-116016

(51) Int. Cl. H01F 1/053; H01F 41/02

(52) U.S. Cl. CPC H01F 1/053; H01F 41/0246
USPC 428/457; 419/31; 419/27; 75/246

(57) ABSTRACT

The present invention provides a rare earth-iron-nitrogen-based alloy material which can produce a rare earth magnet having excellent magnetic characteristics and a method for producing the same, a rare earth-iron-based alloy material suitable as a raw material of the rare earth magnet and a method for producing the alloy material. A rare earth-iron-based alloy material is heat-treated in a hydrogen-containing atmosphere to produce a multi-phase powder 1 in which a phase 3 of a hydrogen compound of a rare earth element is dispersedly present in a phase 2 of an iron-containing material. A powder compact 4 produced by compression-molding the multi-phase powder 1 is heat-treated in a vacuum with a magnetic field of 3 T or more applied, thereby forming a rare earth-iron-based alloy material 5. The rare earth-iron-based alloy material 5 is heat-treated in a nitrogen atmosphere with a magnetic field of 3.5 T or more applied, thereby forming a rare earth-iron-nitrogen-based alloy material 6. The rare earth-iron-based alloy material 5 has a structure in which a crystal of a rare earth-iron-based alloy is oriented in the c-axis direction. The rare earth-iron-nitrogen-based alloy material 6 composed of an ideal nitride can be formed by nitriding the rare earth-iron-based alloy material 5 having this oriented structure with the magnetic field applied, and a rare earth magnet 7 having excellent magnetic characteristics can be formed.

### TECHNICAL FIELD

The present invention relates to a rare earth-iron-nitrogen-based alloy material used for materials of rare-earth magnets, a method for producing the same, a rare earth-iron-based alloy material used as a raw material of the rare earth-iron-nitrogen-based alloy material, and a method for producing the rare earth-iron-based alloy material. In particular, the present invention relates to a rare earth-iron-nitrogen-based alloy material which can produce rare earth magnets having excellent magnetic characteristics and a method for producing the alloy material.

### BACKGROUND ART

Rare earth magnets are widely used as permanent magnets used for motors and power generators. Typical examples of the rare earth magnets include sintered magnets and bond magnets each of which is composed of a R—Fe—B-based alloy (R: a rare earth element, Fe: iron, B: boron), such as Nd (neodymium)-Fe—B. With respect to the bond magnets, magnets composed of a Sm (samarium)-Fe—N (nitrogen)-based alloy are examined as magnets having more excellent magnetic characteristics than magnets composed of a Nd—Fe—B-based alloy.

The bond magnets are each produced by mixing an alloy powder composed of an R—Fe—B-based alloy or a Sm—Fe—N-based alloy with a binder resin and then compression-molding or injection-molding the resultant mixture. In particular, the alloy powders used for the bond magnets are subjected to hydrogenation-disproportionation-desorption-recombination treatment (HDDR treatment, HD: hydrogenation and disproportionation, DR: desorption and recombination) in order to enhance coercive force. Patent Literature 1 discloses that an alloy powder composed of a rare earth-iron-nitrogen alloy is formed by nitriding a powder composed of a rare earth-iron alloy while irradiating the powder with microwaves, and the resultant alloy powder is used for a bond magnet.

### CITATION LIST

### Patent Literature

PTL 1: Japanese Unexamined Patent Application Publication No. 2008-283141

### SUMMARY OF INVENTION

### Technical Problem

However, conventional rare earth magnets have low magnetic force and are thus desired to be improved in magnetic characteristics.

Bond magnets have a low magnetic phase ratio of about 80% by volume at most because of the presence of a binder resin as an inclusion and thus have low magnetic characteristics due to the low magnetic phase ratio.

Accordingly, an object of the present invention is to provide a rare earth-iron-nitrogen-based alloy material which can produce a rare earth magnet having excellent magnetic characteristics, and a method for producing the alloy material. Another object of the present invention is to provide a rare earth-iron-based alloy material suitable as a raw material of a rare earth magnet having excellent magnetic characteristics, and a method for producing the alloy material.

### Solution to Problem

Sintered magnets are easily increased in magnetic phase ratio but have a low degree of freedom of shape. Therefore, in order to produce a rare earth magnet having a high magnetic phase ratio and excellent magnetic characteristics without sintering, the inventors examined the use of powder molding, not molding for forming a bond magnet using a binder resin. Raw material powders generally used for rare earth magnets include an alloy powder composed of a Sm—Fe—N-based alloy and a treated powder produced by HDDR treatment of the alloy powder. These raw material powders are hard and little deformable and thus have low moldability by compression molding and difficulty in improving the density of a powder compact, and consequently magnets having a high magnetic phase ratio cannot be easily formed. Therefore, as a result of various researches for enhancing moldability, the inventors found that when a powder does not have a structure or a rare earth-iron-nitrogen-based alloy or the like in which a rare earth element and iron are bonded together, but has a structure in which a rare earth element and iron are not bonded, that is, an iron component is present independently of a rare earth element component, the powder has high deformability and excellent moldability, thereby producing a powder compact having a high relative density. It was also found that a powder having the specified structure can be produced by specified heat treatment of an alloy powder composed of a rare earth-iron-based alloy. In addition, it was found that a powder compact produced by compression-molding the resultant powder after the heat treatment is subjected to heat treatment under specified conditions to produce a rare earth-iron-based alloy material having a specified oriented structure, and the rare earth-iron-based alloy material is further nitrided under specified conditions to produce a rare earth-iron-nitrogen-based alloy material which can produce a rare earth magnet having excellent magnetic characteristics. The present invention is based on these findings.

A rare earth-iron-based alloy material of the present invention is used as a raw material of a rare earth magnet and includes a compact composed of a plurality of alloy particles which are composed of a rare earth-iron-based alloy containing a rare earth element, and further has specified orientation described below. Specifically, the alloy material satisfies I(a, b, c)/Imax≧0.83 wherein when any desired plane constituting the outer surface of the compact or any desired section of the compact is used as a measurement plane, Imax is a maximum X-ray diffraction peak intensity at the measurement plane, I(a, b, c) is an X-ray diffraction peak intensity along an axis of a crystal lattice constituting the alloy particles present in the measurement plane, and I(a, b, c)/Imax is a ratio of the peak intensity along the axis to the maximum peak intensity. In addition, a, b, and c in I(a, b, c) correspond to plane indices, and I(a, b, c) represents diffraction peak intensity corresponding to any one of the crystal planes (n00), (0n0), and (00n) where n≠0 and an integer.

The rare earth-iron-based alloy material of the present invention having the specified orientation can be produced by, for example, a method for producing a rare earth-iron-based alloy material according to the present invention described below. The method for producing a rare earth-iron-based alloy material according to the present invention relates to a method for producing a rare earth-iron-based alloy material used as a raw material of a rare earth magnet and includes a preparation step, a molding step, and a dehydrogenation step described below.

Preparation step: a step of heat-treating a rare earth-iron-based alloy powder containing a rare earth element in an atmosphere containing a hydrogen element at a temperature equal to or higher than a disproportionation temperature of the rare earth-iron-based alloy to prepare a multi-phase powder composed of multi-phase particles in which a phase of a hydrogen compound of the rare earth element is dispersedly present in a phase of an iron-containing material containing Fe, and the content of the phase of the hydrogen compound of the rare earth element is 40% by volume or less.

Molding step: a step of forming a powder compact by compression-molding the multi-phase powder.

Dehydrogenation step: a step of heat-treating the powder compact in an inert atmosphere or a reduced-pressure atmosphere at a temperature equal to or higher than a recombination temperature of the powder compact to form a rare earth-iron-based alloy material.

The heat treatment in the dehydrogenation step is performed by applying a magnetic field of 3 T (tesla) or more to the powder compact.

The rare earth-iron-based alloy material of the present invention having the specified orientation can be preferably used as a raw material of a rare earth-iron-nitrogen-based alloy material used as a raw material of a rare earth magnet, producing a rare earth-iron-nitrogen-based alloy material of the present invention having specified orientation described below. A rare earth-iron-nitrogen-based alloy material of the present invention is used as a raw material of a rare earth magnet and includes a compact composed of a plurality of alloy particles which are composed of a rare earth-iron-nitrogen-based alloy containing a rare earth element, and further has specified orientation described below. Specifically, the alloy material satisfies I(a, b, c)/Imax≧0.83 wherein when any desired plane constituting the outer surface of the compact or any desired section of the compact is used as a measurement plane, Imax is a maximum X-ray diffraction peak intensity at the measurement plane, I(a, b, c) is an X-ray diffraction peak intensity along an axis of a crystal lattice constituting the alloy particles present in the measurement plane, and I(a, b, c)/Imax is a ratio of the peak intensity along the axis to the maximum peak intensity. In addition, a, b, and c in I(a, b, c) correspond to plane indices, and I(a, b, c) represents diffraction peak intensity corresponding to any one of the crystal planes (n00), (0n0), and (00n) where n≠0 and an integer.

The rare earth-iron-nitrogen-based alloy material of the present invention having the specified orientation can be produced by, for example, a method for producing a rare earth-iron-nitrogen-based alloy material according to the present invention described below. The method for producing a rare earth-iron-nitrogen-based alloy material according to the present invention relates to a method for producing a rare earth-iron-nitrogen-based alloy material used as a raw material of a rare earth magnet and includes the above-described preparation step, molding step, and dehydrogenation step, and further includes a nitriding step described below.

Nitriding step: a step of heat-treating the rare earth-iron-based alloy material produced through the dehydrogenation step described above in an atmosphere containing a nitrogen element at a temperature equal to or higher than a nitriding temperature and equal to or lower than a nitrogen disproportionation temperature of the rare earth-iron-based alloy material to form a rare earth-iron-nitrogen-based alloy material.

The heat treatment in the dehydrogenation step is performed by applying a magnetic field of 3 T (tesla) or more to the powder compact produced through the molding step. In addition, the heat treatment in the nitriding step is performed by applying a magnetic field of 3.5 T (tesla) or more to the rare earth-iron-based alloy material.

Alternatively, the rare earth-iron-nitrogen-based alloy material of the present invention can be produced by, for example, a production method including a step of preparing the rare earth-iron-based alloy material and the nitriding step. In this method, the heat treatment in the nitriding step is performed by applying a specified magnetic field as described above.

In the production method of the present invention, each of the multi-phase particles constituting the multi-phase powder used as a raw material of the powder compact has a plurality of phases including a phase composed of an iron-containing material containing Fe and a Fe compound and a phase composed of a hydrogen compound of the rare earth element, but not a single phase of a rare earth alloy such as an R—Fe—N-based alloy and an R—Fe—B-based alloy. The phase of the iron-containing material is soft and is rich in moldability as compared with the R—Fe—N-based alloy and the R—Fe—B-based alloy and the hydrogen compound of the rare earth element. In addition, the multi-phase particles each contain, as a main component (60% by volume or more), the iron-containing material containing Fe (pure iron), and thus the iron-containing material phase can be sufficiently deformed by compression molding. Further, the iron-containing material phase is uniformly present in the multi-phase particles without being localized. Therefore, the production method of the present invention is capable of sufficiently and uniformly deforming each of the multi-phase particles and forming a powder compact having a high relative density. By using the powder compact having a high relative density, the production method of the present invention is capable of producing a rare earth-iron-nitrogen-based alloy material which can produce a rare earth magnet having a high magnetic phase ratio without sintering and capable of producing a rare earth-iron-based alloy material suitable as a raw material of the rare earth-iron-nitrogen-based alloy material. In addition, in the production method of the present invention, the iron-containing material containing Fe is sufficiently deformed to permit bonding between the multi-phase particles, and thus the rare earth-iron-nitrogen-based alloy material which can produce a rare earth magnet having a magnetic phase ratio of 80% by volume or more, further 90% by volume or more, can be produced without the presence of an inclusion such as a binder resin used in a bond magnet, and a rare earth-iron-based alloy material suitable as a raw material of the rare earth-iron-nitrogen-based alloy material can be produced. In addition, since the multi-phase powder has excellent moldability, and sintering is not performed in the production method of the present invention, the production method has a high degree of shape freedom and is capable of easily forming a compact with a desired shape with substantially no other processing such as cutting or the like even when the compact has any one of various shapes or complicated shapes, for example, a cylindrical shape, a columnar shape, and a pot shape (cylindrical shape with a bottom). Further, no need for the other processing such as cutting can contribute to improvement in material yield and improvement in productivity of rare earth magnets.

In the production method of the present invention, when the powder compact is dehydrogenated to form the rare earth-iron-based alloy material, a strong magnetic field of 3 T or more is applied. In this case, the powder compact is dehydrogenated to bond the rare earth element with Fe, thereby creating a state where a liquid phase (rare earth-rich phase) having a high rare earth element content is present around crystal nuclei produced by the reaction. In this state, when the specified strong magnetic field is applied, the crystal nuclei easily have crystal orientation in a predetermined direction. As a result, at the time of completion of the reaction, the crystal grains have the predetermined crystal orientation, producing the rare earth-iron-based alloy material of the present invention having the above-described specified orientated texture.

In the production method of the present invention, when the rare earth-iron-based alloy material having the specified oriented structure is nitrided to form the rare earth-iron-nitrogen-based alloy material, a strong magnetic field of 3.5 T or more is applied. Since the specified strong magnetic field is also applied in the nitriding step, the crystal lattice of the crystal grains constituting the rare earth-iron-based alloy material is distorted by a magnetostrictive effect. Specifically, the distance between Fe atoms constituting the crystal lattice is stretched in the direction in which the magnetic field is applied. In addition, since the rare earth-iron-based alloy material having the specified oriented structure is used as a raw material to be supplied in the nitriding step, the distance between Fe atoms is easily stretched in a specified direction (typically, orientation direction) in the crystal lattice in the nitriding step in which the specified strong magnetic field is applied. Thus, N atoms easily enter between the Fe atoms at the stretched distance therebetween. That is, in the nitriding step, the direction in which N atoms enter can be controlled. Therefore, it is considered that N atoms can be easily arranged ideal positions in the crystal lattice, and thus the rare earth-iron-nitrogen-based alloy material composed of a rare earth-iron-nitrogen-base alloy having an ideal atomic ratio can be formed. The alloy (for example, Sm₂Fe₁₇N₃) in an ideal state is an anisotropic nitride and can produce a rare earth magnet having excellent magnetic characteristics as compared with the use of a rare earth-iron-nitrogen-based alloy composed of an isotropic nitride generally used for bond magnets.

The rare earth-iron-based alloy material of the present invention has the specified oriented structure as described above and thus can be preferably used as a raw material of the rare earth-iron-nitrogen-based alloy material having an ideal atomic ratio. By using the raw material, the rare earth-iron-nitrogen-based alloy material of the present invention substantially maintains the orientation of the raw material (typically, the rare earth-iron-based alloy material of the present invention) and has the specified oriented structure as described above. The rare earth-iron-nitrogen-based alloy material of the present invention can be easily composed of the nitride in an ideal state as described above, and thus a rare earth magnet having excellent magnetic characteristics can be produced.

The rare earth-iron-based alloy material of the present invention and the rare earth-iron-nitrogen-based alloy material of the present invention may have a configuration in which Ic/Imax≧0.83 is satisfied, where Ic is the X-ray diffraction peak intensity along a c-axis of the crystal lattice. Ic represents the diffraction peak intensity corresponding to a crystal plane (00n) where n=an integer of 2 to 6.

The above-described configuration has orientation in the c-axis direction, i.e., the c-axis is an easy magnetization axis. By using the rare earth-iron-based alloy material and the rare earth-iron-nitrogen-based alloy material which have orientation in the c-axis direction and satisfy Ic/Imax≧0.83, a rare earth magnet having excellent magnetic characteristics can be produced.

The rare earth-iron-based alloy material of the present invention and the rare earth-iron-nitrogen-based alloy material of the present invention may have a configuration in which the rare earth element is Sm.

Examples of the rare earth-iron-based alloy having the above-described configuration include an Sm—Fe-based alloy and an Sm—Fe—Ti-based alloy, and examples of the rare earth-iron-nitrogen-based alloy having the above-described configuration include an Sm—Fe—N-based alloy and an Sm—Fe—Ti—N-based alloy. The Sm-containing configuration such as the Sm—Fe—N-based alloy material or Sm—Fe—Ti—N-based alloy material produces a rare earth magnet having excellent magnetic characteristics.

The rare earth-iron-based alloy material of the present invention and the rare earth-iron-nitrogen-based alloy material of the present invention may have a configuration in which the alloy contains Sm and Ti.

Examples of the rare earth-iron-based alloy having the above-described configuration include an Sm—Fe—Ti-based alloy, and examples of the rare earth-iron-nitrogen-based alloy having the above-described configuration include an Sm—Fe—Ti—N-based alloy. In producing the rare earth-iron-nitrogen-based alloy material composed of, for example, Sm₂Fe₁₇N₃, it is considered to use the rare earth-iron-based alloy material composed of Sm₂Fe₁₇ as a raw material. In order to form an ideal nitride, i.e., Sm₂Fe₁₇N₃ in which the atomic ratio of nitrogen element is 3, by nitriding Sm₂Fe₁₇, it is necessary to control the ratio of nitrogen element with high precision, and this control results in a decrease in productivity of the rare earth-iron-nitrogen-based alloy material. However, by using the rare earth-iron-based alloy containing Sm and Ti, i.e., a Sm—Fe—Ti-based alloy, more specifically Sm₁Fe₁₁Ti₁, Sm₁Fe₁₁Ti₁ can be stably and uniformly nitrided. In addition, Sm₁Fe₁₁Ti₁ contains an iron-containing material (typically, Fe and FeTi) at a high ratio to the rare earth element Sm as composed with a rare earth-iron-based alloy not containing Ti, for example, Sm₂Fe₁₇. Specifically, Sm₂Fe₁₇ has Sm:Fe=2:17, while Sm₁Fe₁₁Ti₁ has Sm:Fe:Ti=1:11:1, i.e., Sm:(Fe+FeTi)=1:12. Therefore, when the multi-phase powder composed of the multi-phase particles each containing the iron-containing material phase containing Fe and FeTi compound and the Sm hydrogen compound phase is used as the raw material of the rare earth-iron-based alloy material composed of Sm₁Fe₁₁Ti₁, moldability is excellent because a large amount of the iron-containing component rich in moldability is present. Further, by using the multi-phase powder, the powder compact having a high density can be stably and easily produced. Further, the use of the raw material containing Ti leads to the suppression of the use amount of Sm, which is a rare source. Based on the above-described finding, the configuration containing Sm and Ti is proposed.

In the above-described configuration, as described above, excellent moldability of the powder compact and excellent stability and uniformity of nitriding can be achieved, productivity of the rare earth-iron-nitrogen-based alloy material (typically, composed of Sm₁Fe₁₁Ti₁N₁) is excellent. Also, in the configuration, the powder compact having a high density can be utilized, and thus a rare earth magnet having a high magnetic phase ratio and excellent magnetic characteristics can be formed.

The production method of the present invention may have a configuration in which a high-temperature superconducting magnet is used for applying the magnetic field in the dehydrogenation step and the nitriding step.

In this configuration, the strong magnetic field of 3 T or more or 3.5 T or more can be stably applied and can be rapidly changed, and thus a proper magnetic field strength can be easily determined according to change in the crystal structure during heat treatment, thereby causing excellent workability. In addition, the treatment time can be shortened, thereby enhancing productivity of the rare earth-iron-based alloy material of the present invention and the rare earth-iron-nitrogen-based alloy material of the present invention.

The method for producing the rare earth-iron-nitrogen-based alloy material may have a configuration in which a direction in which the magnetic field is applied in the nitriding step is the same as a direction in which the magnetic field is applied in the dehydrogenation step.

In this configuration, since the magnetic field is applied in the same direction, the crystal orientation in a direction produced by applying the magnetic field in the dehydrogenation step can be stretched in the same direction in the nitriding step. Therefore, in this configuration, the direction of entering of N atoms can be more easily controlled, and an ideal nitride can be easily formed with high efficiency.

### Advantageous Effects of Invention

By using the rare earth-iron-nitrogen-based alloy material of the present invention, a rare earth magnet having excellent magnetic characteristics can be formed. The rare earth-iron-based alloy material of the present invention can be preferably used as a raw material of the rare earth-iron-nitrogen-based alloy material of the present invention. The method for producing the rare earth-iron-nitrogen-based alloy material of the present invention and the method for producing the rare earth-iron-based alloy material of the present invention can be preferably used for producing the rare earth-iron-nitrogen-based alloy material of the present invention and the rare earth-iron-based alloy material of the present invention, respectively.

### BRIEF DESCRIPTION OF DRAWINGS

FIG. 1 is an explanatory process drawing schematically illustrating an example of a process for producing a rare earth-iron-nitrogen-based alloy material of the present invention.

### DESCRIPTION OF EMBODIMENTS

The present invention is described in further detail below.

[Method for Producing Rare Earth-Iron-Based Alloy Material]

(Preparation Step)

Constituent elements of a rare earth-iron-based alloy (hereinafter referred to as a “starting alloy”) may be selected so that a rare earth-iron-based alloy powder (hereinafter referred to as a “starting alloy powder”) used as a raw material of the multi-phase powder produces a multi-phase powder having a desired composition. Examples of the starting alloy include REₓMe₁₇ and Re_{x/2}Me₁₂ wherein RE is a rare earth element (for example, at least one element selected from RE=Y, La, Pr, Nd, Sm, Dy, and Ce), Me is Fe or Fe and an element (for example, at least one element selected from Co, Ni, Mn, and Ti) other than Fe, and x=2.0 to 2.2.

The starting alloy powder can be produced by, for example, grinding a melt cast ingot composed of a desired rare earth-iron-based alloy or a foil-shaped material, which is obtained by a rapid solidification method, with a grinder. Examples of the grinder include a jaw crusher, a jet mill, or a ball mill, and the like. Alternatively, the starting alloy powder can be produced by using an atomization method such as a gas atomization method or by further grinding a powder produced by the atomization method. The gas atomization method can form a powder (oxygen concentration: 500 ppm by mass or less) containing substantially no oxygen in a non-oxidizing atmosphere. The starting alloy powder can be produced by using a known production method. In addition, the particle size distribution and the shape of the starting alloy powder can be adjusted by appropriately changing the grinding conditions or the production conditions, and besides spherical particles, irregular-shape particles or foil strips may be used. By using the atomization method, a powder having high sphericity and excellent filling properties during compression molding can be easily produced. The particles constituting the starting alloy powder may be each composed of a polycrystal or a single crystal. Particles composed of a single crystal can be formed by appropriate heat treatment of particles composed of a polycrystal.

The size of the starting alloy powder is maintained when in a subsequent step of heat treatment (hydrogenation), the heat treatment (hydrogenation) is performed so as substantially not to change the particle size. Since the multi-phase powder produced after the heat treatment (hydrogenation) has the specified structure including a plurality of the phases and is thus excellent in moldability as described above, the multi-phase powder can be made relatively coarse so that the multi-phase particles have an average particle diameter of about 100 μm. Therefore, the starting alloy powder having an average particle diameter of about 100 μm can be used. Such a coarse starting alloy powder can be produced by coarsely grinding a melt cast ingot or by using the atomization method such as a melt atomization method. Since such a coarse starting alloy powder can be used, the need for fine grinding to form a fine powder such as a raw material powder used for producing a bond magnet can be eliminated, thereby permitting an attempt to decrease the production cost by shortening the production process. The average particle diameter of the starting alloy powder (average particle diameter of the resultant multi-phase powder) is 10 μm or more and 500 μm or less, and more preferably 30 μm or more and 200 μm or less because a powder compact having a high relative density can be easily formed.

The multi-phase powder can be formed by heat-treating (hydrogenating) the starting alloy powder in a hydrogen element-containing atmosphere at a specified temperature. As the hydrogen element-containing atmosphere, a single atmosphere containing only hydrogen (H₂), or a mixed atmosphere containing hydrogen (H₂) and inert gas, such as Ar or N₂, can be used. The temperature of heat treatment (hydrogenation) is equal to or higher than the temperature, i.e., a disproportionation temperature, at which disproportionation reaction of the rare earth-iron-based alloy constituting the starting alloy powder proceeds. The disproportionation reaction is a reaction of separating the hydrogen compound of a rare earth element and Fe (or Fe and iron compound) from each other by preferential hydrogenation of the rare earth element, and the lower limit temperature at which the reaction takes place is referred to as the disproportionation temperature. The disproportionation temperature varies with the composition of the rare earth-iron-based alloy and the type of the rare earth element. For example, when the rare earth-iron-based alloy is Sm₂Fe₁₇ or Sm₁Fe₁₁Ti₁, the heat treatment temperature is, for example, 600° C. or more. With the heat treatment (hydrogenation) temperature near the disproportionation temperature, the hydrogen compound of the rare earth element is easily made to have a layered form, while with the heat treatment temperature 100° C. or more higher than the disproportionation temperature, the hydrogen compound of the rare earth element is easily made to have a granular form. The higher the heat treatment (hydrogenation) temperature is, the more easily matrixing of the iron-containing material phase proceeds, thereby producing the multi-phase powder having excellent moldability. However, with an excessively high heat treatment temperature, a trouble such as melt fixing of the starting alloy powder occurs, and thus the heat treatment temperature is preferably 1100° C. or less. When the rare earth-iron-based alloy is Sm₂Fe₁₇ or Sm₁Fe₁₁Ti₁, with the relatively low temperature of 700° C. or more and 900° C. or less during the heat treatment (hydrogenation), a fine structure having a small phase distance described below can be easily realized. The retention time during the heat treatment (hydrogenation) is, for example, 0.5 hours or more and 5 hours or less. The heat treatment (hydrogenation) corresponds to the treatment up to the disproportionation step of the above-described HDDR treatment, and known disproportionation conditions can be applied. The heat treatment (hydrogenation) can be performed by using a rocking furnace such as a rotary kiln besides a general heating furnace. By using the rocking furnace, even when a relatively large raw material such as a cast lamp is used, the material is ground due to embrittlement as hydrogenation proceeds, producing a powder.

The particles (hereinafter referred to as the “multi-phase particles) constituting the multi-phase powder produced by the heat treatment (hydrogenation) each contain an iron-containing material as a main component at a content of 60% by volume or more. When the content of the iron-containing material is less than 60% by volume, the hydrogen compound of the rare earth element which is hard is relatively increased in amount, and thus the iron-containing material is not easily sufficiently deformed during compression molding, while when the content of the iron-containing material is excessively high, magnetic characteristics are finally degraded. Therefore, the content is preferably 90% by volume or less.

The iron-containing material may have (1) a form containing only Fe (pure iron), (2) a form in which Fe is partially substituted by at least one element selected from Co, Ga, Cu, Al, Si, and Nb and which contains Fe and the substitution element, (3) a form containing Fe and a Fe-containing iron compound (for example, a FeTi compound, a FeMn compound, or the like), or (4) a form containing Fe, the substitution element or an element other than Fe (for example, Ni, Mn, Ti, or the like), and the iron compound. When the iron-containing material has the form containing the substitution element and an element other than Fe, magnetic characteristics and corrosion resistance can be improved. The form containing an iron compound such as FeTi exhibits the excellent effect that (1) as described above, a powder compact having a high density can be produced because of excellent moldability due to an increase in ratio of the iron-containing material relative to the rare earth element, (2) nitriding after heat treatment (dehydrogenation) can be easily stably performed, and (3) the rare earth-iron-nitrogen-based alloy material and the rare earth magnet having a high magnetic phase ratio can be formed.

The content of the hydrogen compound of the rare earth element preferably exceeds 0% by volume and 10% by volume or more and less than 40% by volume.

The content of the iron-containing material, the content of each of the constituent elements of the iron-containing material, and the content of the hydrogen compound of the rare earth element can be adjusted by appropriately changing the composition of the starting alloy powder and the heat treatment conditions (mainly the temperature) for producing the multi-phase powder. In the case of the form containing the substitution element and the element other than Fe, the starting alloy containing the substitution element is used. Each of the multi-phase particles is allowed to contain inevitable impurities.

The rare earth element contained in each of the multi-phase particles is at least one element selected from Sc (scandium), Y (yttrium), lanthanides, and actinides. In particular, when Sm which is a lanthanide is used, an Sm—Fe-based alloy material and an Sm—Fe—Ti-based alloy material can be produced. An Sm—Fe—N-based alloy material and an Sm—Fe—Ti—N-based alloy material can be produced using the Sm—Fe-based alloy material and the Sm—Fe—Ti-based alloy material, respectively, as a raw material, and a rare earth magnet having excellent magnetic characteristics can be formed using the Sm—Fe—N-based alloy material or the Sm—Fe—Ti—N-based alloy material as a raw material. When another rare earth element is contained in addition to Sm, for example, at least one element of Pr (praseodymium), Dy (dysprosium), La (lanthanum), and Y is preferred. An example of the hydrogen compound of the rare earth element is SmH₂.

Each of the multi-phase particles has a structure in which a phase of the hydrogen compound of the rare earth element and a phase of the iron-containing material are uniformly dispersedly present. This dispersed state represents that in each of the multi-phase particles, the phase of the hydrogen compound of the rare earth element and the phase of the iron-containing material are present adjacent to each other, and the distance between the phases of the hydrogen compound of the rare earth element adjacent to each other with the phase of the iron-containing material interposed therebetween is 3 μm or less. Typical examples of the structure include a layered form in which both phases are present in a multilayer structure, and a granular form in which the phase of the hydrogen compound of the rare earth element is granular, and the granular hydrogen compound of the rare earth element is dispersedly present in the phase of the iron-containing material serving as a mother phase.

In the granular form, the iron-containing material is uniformly present around the particles composed of the hydrogen compound of the rare earth element, and thus the iron-containing material can be more easily deformed than in the layered form. For example, a powder compact having a complicated shape and a high-density powder compact having a relative density of 85% or more, further 90% or more, and particularly 95% or more, can be easily formed. In the case of the granular form, the sentence “the phase of the hydrogen compound of the rare earth element and the phase of the iron-containing material are adjacent to each other” typically represents a condition in which in a cross-section of each of the multi-phase particles, the iron-containing material is present to cover the peripheries of particles of the hydrogen compound of the rare earth element, and the iron-containing material is present between the adjacent particles of the hydrogen compound of the rare earth element. In addition, in the case of the granular form, the expression “the distance between the adjacent phases of the hydrogen compound of the rare earth element” refers to, in the cross-section, the center-to-center distance between the adjacent two particles of the hydrogen compound of the rare earth element.

With the distance of 3 μm or less, input of excessive energy is not required in a dehydrogenation step, and coarsening of crystals of the rare earth-iron-based alloy produced in the dehydrogenation step can be suppressed, thereby finally easily producing a rare earth magnet having high coercive force. In order to allow the iron-containing material to be sufficiently present between the phases of the hydrogen compound of the rare earth element, the distance is preferably 0.5 μm or more, particularly 1 μm or more. The phase distance can be adjusted by changing the composition of the starting alloy powder or changing the heat treatment (hydrogenation) conditions for producing the multi-phase powder. For example, the distance tends to be increased by increasing the ratio (atomic ratio) of iron in the rare earth-iron-based alloy constituting the starting alloy or increasing the temperature of the heat treatment (hydrogenation).

The multi-phase powder may have a configuration in which an antioxidant layer and an insulating coating are provided to cover the entire periphery of each multi-phase particle. The configuration provided with the antioxidant layer can prevent oxidation of a newly formed surface formed during compression molding and can suppress a decrease in the magnetic phase ratio due to an oxide. The configuration provided with the insulating coating can form a rare earth magnet having high electric resistance and a low eddy-current loss.

The antioxidant layer preferably includes at least a low-oxygen-permeable layer composed of a low-oxygen-permeable material having an oxygen permeability coefficient (30° C.) of less than 1.0×10⁻¹¹ m³·m/(s·m²·Pa), particularly 0.01×10⁻¹¹ m³·m/(s·m²·Pa) or less. Examples of the low-oxygen-permeable material include polyamides such as nylon 6 (oxygen permeability coefficient (30° C.): 0.0011×10⁻¹¹ m³·m/(s·m²·Pa), and other materials such as polyester, polyvinyl chloride, and the like. In addition, the antioxidant layer preferably includes a low-moisture-permeable layer composed of a low-moisture-permeable material having a moisture permeability coefficient (30° C.) of less than 1000×10⁻¹³ kg/(m·s·MPa), particularly 10×10⁻¹³ kg/(m·s·MPa) or less in addition to the low-oxygen-permeable layer because oxidation can be effectively prevented during compression molding even under a humid condition (e.g., air temperature of about 30° C./humidity of about 80%). Examples of the low-moisture permeable material include polyethylene having a moisture permeability coefficient (30° C.) of 7×10⁻¹³ kg/(m·s·MPa) to 60×10⁻¹³ kg/(m·s·MPa) and other materials such as fluorocarbon resins, polypropylene, and the like. The low-oxygen permeable layer is preferably provided on the multi-phase particle side, and the low-moisture-permeable layer is preferably provided on the low-oxygen-permeable layer. The thickness of each of the layers constituting the antioxidant layer is preferably 10 nm or more and 500 nm or less.

The antioxidant layer can be formed by using a wet method, for example, a wet dry coating method or a sol-gel method, or a dry method such as powder coating.

Examples of the insulating coating include crystalline coatings and amorphous glass coatings of oxides of Si, Al, Ti, and the like; and coatings composed of metal oxides such as ferrite of Me—Fe—O (X=a metal element of Ba, Sr, Ni, Mn, or the like), magnetite (Fe₃O₄), and Dy₂O₃; resins such as silicone resins; and organic-inorganic hybrid compounds such as silsesquioxane compounds. These crystalline coatings, glass coatings, and oxide coatings may have the antioxidant function, and in this case, oxidation of the multi-phase particles can also be prevented. Further, a Si—N-based or Si—C-based ceramic coating may be provided on the multi-phase particles for the purpose of improving thermal conductivity.

In the configuration provided with the insulating coating and both the ceramic coating and the antioxidant layer, preferably, the insulating coating is formed to be in contact with the surface of each multi-phase particle, and then the ceramic coating and the antioxidant layer are formed on the insulating coating. In the configuration provided with the insulating coating and the antioxidant layer, the multi-phase particles preferably have a shape close to a spherical shape because it is possible to achieve the effect that (1) the antioxidant layer and the insulating coating can be easily formed with a uniform thickness, and (2) breakage of the antioxidant layer and the insulating coating during compression molding can be suppressed.

(Molding Step)

A powder compact can be produced by compression-molding the multi-phase powder. The powder compact having a higher relative density (actual density relative to the true density of the powder compact) can easily form a final rare earth magnet having a higher magnetic phase ratio. Therefore, the powder compact preferably has a relative density of 85% or more. When the relative density of the powder compact is about 90% to 95%, in the configuration provided with the antioxidant layer, the antioxidant layer can be easily removed in a subsequent step.

When the multi-phase particles constituting the multi-phase powder each have the configuration containing the Sm hydrogen compound and the iron-containing material containing Fe and the FeTi compound, as described above, the powder compact having a relative density of 90% or more can be stably produced because of excellent moldability.

Since the multi-phase powder has excellent moldability, the pressure of compression molding can be decreased to a relatively low value. For example, the pressure can be decreased to 8 ton/cm² or more and 15 ton/cm² or less. In addition, since each of the multi-phase particles can be sufficiently deformed, it is possible to produce a powder compact having high strength and being little breakable during production because of excellent bondability between the multi-phase particles (development of strength (so-called necking strength) produced by engagement between surface projections and recesses of the magnetic particles).

Compression molding is preferably performed in a non-oxidizing atmosphere because oxidation of the multi-phase particles can be prevented. In the configuration provided with the antioxidant layer, compression molding may be performed in an oxygen-containing atmosphere such as an air atmosphere.

In addition, deformation can be accelerated by appropriately heating a mold during compression molding, and consequently a powder compact having a high density and a powder compact having a complicated shape can be easily produced.

(Dehydrogenation Step)

In the dehydrogenation step, heat treatment is performed in a nonhydrogen atmosphere so as to avoid reaction with the multi-phase particles and permit efficient removal of hydrogen. The nonhydrogen atmosphere is an inert atmosphere or a reduced-pressure atmosphere. The inert atmosphere is, for example, Ar or N₂. The reduced-pressure atmosphere represents a vacuum state under pressure lower than the standard atmospheric pressure, and the final vacuum degree is preferably 10 Pa of less and more preferably 1 Pa or less. Hydrogen is preferably removed from the hydrogen compound of the rare earth element in the reduced-pressure atmosphere because the rare earth-iron-based alloy can be completely created leaving little hydrogen compound of the rare earth element, and a rare earth magnet having excellent magnetic characteristics can be produced by using the resultant rare earth-iron-based alloy material as a raw material.

The temperature of the heat treatment (dehydrogenation) in the dehydrogenation step is equal to or higher than the recombination temperature (the temperature of combination of the separated iron-containing material and rare earth element) of the powder compact. The recombination temperature varies depending on the composition of the multi-phase particles constituting the powder compact, but is typically 600° C. or more. The higher the temperature is, the more sufficiently hydrogen can be removed. However, when the heat treatment (dehydrogenation) temperature is excessively high, the rare earth element having a high vapor pressure may be decreased in amount by evaporation or the coercive force of a rare earth magnet may be decreased due to coarsening of rare earth-iron-based alloy crystals produced by the heat treatment. Therefore, the temperature is preferably 1000° C. or less. The retention time of the heat treatment (dehydrogenation) is, for example, 10 minutes or more and 600 minutes or less. The DR treatment conditions in known HDDR treatment can be applied to the temperature condition.

In the dehydrogenation step, heat treatment (dehydrogenation) of the powder compact is performed while a magnetic field is applied. The magnetic field is a strong magnetic field of 3 T or more. The strong magnetic field can be stably formed by using a high-temperature superconducting magnet. In addition, with the superconducting magnet, the magnetic field can be rapidly changed. When a low-temperature superconducting magnet is used, a rate of change of the magnetic field is generally about 5 minutes to 10 minutes per 1T, while with the high-temperature superconducting magnet, the magnetic field can be changed within a very short time, for example, 10 seconds or less per 1T. That is, since a desired strong magnetic field can be easily attained within a short heat treatment time, the heat treatment time can be shortened by using the high-temperature superconducting magnet. As a result of shortening of the heat treatment time, crystal grain growth in the particles constituting the compact can be suppressed to decrease coarsening, and thus a rare earth magnet having high coercive force can be easily produced. Further, because of the high rate of change in the magnetic field, application of the magnetic field can be rapidly controlled so as to stop (OFF) the application of the magnetic field during charging or removal of the raw material or start (ON) the application of the magnetic field during heat treatment. Therefore, the heat treatment can be continuously performed by using the high-temperature superconducting magnet, thereby causing excellent productivity of the rare earth-iron-based alloy material. The high-temperature superconducting magnet is typically used by conduction-cooling a superconducting coil composed of an oxide superconductor using, for example, a refrigerator (operating temperature of about −260° C. or more). The magnetic field with a magnitude of less than 3 T has a difficulty in orienting, in a direction, crystal nuclei containing the rare earth element and Fe formed by removal of hydrogen due to magnetostriction. As the magnitude of the magnetic field increases, the crystal orientation is more easily aligned in a direction, thereby finally producing a rare earth magnet having excellent magnetic characteristics. Therefore, the magnetic field is preferably 3.2 T or more and more preferably 4 T or more. The direction in which the magnetic field is applied is preferably the same as the molding direction (compression direction) of molding of the powder compact.

In the case of the configuration provided with the antioxidant layer composed of a material such as a resin which can be removed by heating, the heat treatment in the dehydrogenation step can also be performed for removing the antioxidant layer. The heat treatment (coating removal) for removing the antioxidant layer may be performed separately. The heat treatment (coating removal) can be performed, for example, at a heating temperature of 200° C. or more and 400° C. or less for a retention time of 30 minutes or more and 300 minutes or less, depending on the material of the antioxidant layer. The heat treatment (coating removal) can effectively prevent the occurrence of residue of the antioxidant layer.

By using the above-described powder compact, the degree of change in volume (amount of contraction after the heat treatment (dehydrogenation)) before and after the dehydrogenation step is decreased. For example, the rate of volume change can be decreased to 5% or less. Therefore, post-processing such as cutting or like for forming a final shape can be eliminated, and thus productivity of the rare earth-iron-based alloy material and the rare earth-iron-nitrogen-based alloy material can be enhanced.

[Rare Earth-Iron-Based Alloy Material]

Each of the multi-phase particles constituting the powder compact becomes a particle (hereinafter referred to as a “raw material alloy particle”) composed of a rare earth-iron-based alloy by the heat treatment (dehydrogenation), producing the rare earth-iron-based alloy material (typically, the rare earth-iron-based alloy material of the present invention) including the compact in which powder grain boundaries of the multi-phase powder remain. Examples of the alloy material include REₓMe₁₇ and Re_{x/2}Me₁₂ wherein RE is at least one element selected from RE=Y, La, Pr, Nd, Sm, Dy, and Ce, Me is Fe or Fe and at least one element selected from Co, Ni, Mn, and Ti, and x=2.0 to 2.2. Examples of REₓMe₁₇ include Sm—Fe-based alloys such as Sm₂Fe₁₇, and Y—Fe-based alloys such as Y₂Fe₁₇, and examples of Re_{x/2}Me₁₂ include Sm—Fe—Ti-based alloys such as Sm₁(Fe₁₁Ti₁), Sm—Fe—Mn-based alloys such as Sm₁(Fe₁₁Mn₁), Y—Fe—Ti-based alloys such as Y₁(Fe₁₁Ti₁), and Y—Fe—Mn-based alloys such as Y₁(Fe₁₁Mn₁). The compact has high peak intensity along at least one of the a-axis, b-axis, and c-axis of the crystal constituting the raw material alloy particle. That is, the compact has a structure in which the crystal orientation of the crystal is aligned in parallel with an axis direction of the crystal lattice, more specifically, a structure satisfying I(a, b, c)/Imax≧0.83. Any one of the above-described Sm—Fe-based alloy, Y—Fe-based alloy, Sm—Fe—Ti-based alloy, Sm—Fe—Mn-based alloy, Y—Fe—Ti-based alloy, and Y—Fe—Mn-based alloy has orientation in the c-axis direction, is a rare earth alloy having the c-axis serving as an easy magnetization axis, and satisfies Ic/Imax≧0.83. Orientation in the a-axis direction or b-axis direction may be caused according to the composition of the rare earth-iron-based alloy.

As the ratio I(a, b, c)/Imax of the peak intensity along an axis to the maximum peak intensity increases, orientation is enhanced, and the ratio is preferably 0.90 or more and most preferably 1. As the magnitude of the magnetic field applied during the heat treatment (dehydrogenation) is increased, I(a, b, c)/Imax tends to be increased.

When the compact has a shape constituted of planes, such as a parallelepiped, or a shape having a plane, such as a cylindrical shape, X-ray diffraction is performed using any desired plane as a measurement plane. When the compact has a shape having a curved surface or a shape having a plane and a curved surface, such as a cylindrical shape, X-diffraction is performed using any desired section as a measurement plane. The I(a, b, c) at the measurement plane represents the peak intensity along an axis having the maximum peak intensity among the peak intensities along the a-axis, b-axis, and c-axis. When a plane is used as the measurement plane or a section is used as the measurement plane, the maximum peak intensity is regarded as I(a, b, c). The measurement plane is, for example, a surface having a normal line in the direction in which the magnetic field is applied. These matters concerning X-ray diffraction apply to the rare earth-iron-nitrogen-based alloy material described below.

The compact has a single form including substantially the rare earth-iron-based alloy, or a mixed form including substantially the rare earth-iron-based alloy and iron. Since with the single form, Sm₂Fe₁₇N₃ having excellent magnetic characteristics can be formed by heat treatment (nitriding) described below, the form composed of Sm₂Fe₁₇ is preferred. On the other hand, the single form composed of Sm₁Fe₁₁Ti₁ is preferred because nitriding can be stably and uniformly performed over the entire region of the compact, and Sm₁Fe₁₁Ti₁N₁ having excellent magnetic characteristics can be produced after the heat treatment (nitriding).

The mixed form varies depending on the composition of the rare earth-iron-based alloy constituting the starting alloy powder described above. For example, a compact (rare earth-iron-based alloy material) including an iron phase and a rare earth-iron-based alloy phase can be formed by using the powder having a high iron ratio (atomic ratio).

[Method for Producing Rare Earth-Iron-Nitrogen-Based Alloy Material]

The rare earth-iron-based alloy material produced through the dehydrogenation step described above is heat-treated (nitrided) under specified conditions to produce the rare earth-iron-nitrogen-based alloy material (typically, the rare earth-iron-nitrogen-based alloy material of the present invention).

Examples of an atmosphere containing nitrogen element in the nitriding step include a single atmosphere containing nitrogen (N₂) alone, an ammonia (NH₃) atmosphere, a mixed gas atmosphere containing nitrogen element-containing gas, such as nitrogen (N₂) or ammonia, and inert gas such as Ar, and a mixed gas atmosphere containing the nitrogen element-containing gas and hydrogen (H₂). In particular, the atmosphere containing hydrogen gas is a reducing atmosphere and is thus preferred because oxidation and excessive nitriding of the produced nitride can be prevented.

The temperature of heat treatment (nitriding) is equal to or higher than a temperature (nitriding temperature) at which the rare earth-iron-based alloy constituting the rare earth-iron-based alloy material reacts with nitrogen element and is equal to or lower than a nitrogen disproportionation temperature (temperature at which the iron-containing material and the rare earth element each separately independently react with nitrogen element). The nitriding temperature and the nitrogen disproportionation temperature vary depending on the composition of the rare earth-iron-based alloy. For example, when the rare earth-iron-based alloy is Sm₂Fe₁₇ or Sm₁Fe₁₁Ti₁, the heat treatment (nitriding) temperature is 200° C. or more and 550° C. or less (preferably 300° C. or more). The retention time of heat treatment (nitriding) is, for example, 10 minutes or more and 600 minutes or less.

In the nitriding step, heat treatment (nitriding) of the rare earth-iron-based alloy material is performed while a magnetic field is applied. The magnetic field is a strong magnetic field of 3.5 T or more. The strong magnetic field can be stably formed by using a high-temperature superconducting magnet. The magnetic field with a magnitude of less than 3.5 T has difficulty in stretching, in a direction, the crystal lattice of a crystal constituting the rare earth-iron-based alloy material. As the magnitude of the magnetic field increases, the crystal lattice is more easily stretched in a direction, and N atoms are more easily allowed to enter between the Fe atoms with the stretched distance therebetween, thereby easily producing a nitride having an ideal atomic ratio. Therefore, the magnetic field is preferably 3.7 T or more and more preferably 4 T or more.

By using the rare earth-iron-based alloy material of the present invention, the rate of change in volume before and after the nitriding step can also be decreased and, for example, the rate of change in volume can be decreased to 5% or less. Therefore, post-processing such as cutting for forming a final shape can be omitted by using the rare earth-iron-based alloy material of the present invention, and thus productivity of the rare earth-iron-nitrogen-based alloy material can be enhanced.

[Rare Earth-Iron-Nitrogen-Based Alloy Material]

Each of the law material alloy particles constituting the rare earth-iron-based alloy material becomes an alloy particle (hereinafter referred to as a “raw material alloy particle”) composed of a rare earth-iron-nitrogen-based alloy by the heat treatment (nitriding), producing the rare earth-iron-nitrogen-based alloy material (typically, the rare earth-iron-nitrogen-based alloy material of the present invention) including the compact in which grain boundaries of the raw material alloy particle remain. Examples of the rare-earth-iron-nitrogen-based alloy material include RE₂Me₁₇Nₓ and RE₁Me₁₂Nₓ wherein RE and Me are as described above (x=1.5 to 3.5). More specific examples thereof include Sm₂Fe₁₇N₃, Y₂Fe₁₇N₃, Sm₁(Ti₁Fe₁₁)N₂, Sm₁(Mn₁Fe₁₁)N₂, Y₁(Ti₁Fe₁₁)N₂, and Y₁(Mn₁Fe₁₁)N₂. As described above, the compact substantially maintains the orientation of the rare earth-iron-based alloy material and has high peak intensity along at least one of the a-axis, b-axis, and c-axis of the crystal constituting the raw material alloy particle. That is, the compact has a structure in which the crystal orientation of the crystal is aligned in parallel with an axis direction of the crystal lattice, more specifically, a structure satisfying I(a, b, c)/Imax≧0.83. Any one of the above-described Sm—Fe—N-based alloy, Y—Fe—N-based alloy, Sm—Fe—Ti—N-based alloy, Sm—Fe—Mn—N-based alloy, Y—Fe—Ti—N-based alloy, and Y—Fe—Mn—N-based alloy has a structure with orientation along the c-axis and satisfies Ic/Imax≧0.83. Orientation in the a-axis direction or b-axis direction may be caused according to the composition of the rare earth-iron-nitrogen-based alloy.

As the ratio I(a, b, c)/Imax of the peak intensity along an axis to the maximum peak intensity increases, the orientation is enhanced, producing a rare earth magnetic having excellent magnetic characteristics. Therefore, the ratio is preferably 0.90 or more and most preferably 1. As the magnitude of the magnetic field applied during the heat treatment (nitriding) is increased, I(a, b, c)/Imax tends to be increased.

[Rare Earth Magnet]

A rare earth magnet can be produced by appropriately magnetizing the above-described rare earth-iron-nitrogen-based alloy material of the present invention. In particular, by using the above-described powder compact having a high relative intensity, a rare earth magnet having a magnetic phase ratio of 80% by volume or more, still more 90% by volume or more, can be produced.

The rare earth magnet produced by magnetizing the rare earth-iron-nitrogen-based alloy material composed of the Sm—Fe—Ti—N-based alloy such as Sm₁Fe₁₁Ti₁N₁ has excellent magnetic characteristics even if the Sm content is lower than that of a Sm—Fe—N-based alloy such as Sm₂Fe₁₇N₃.

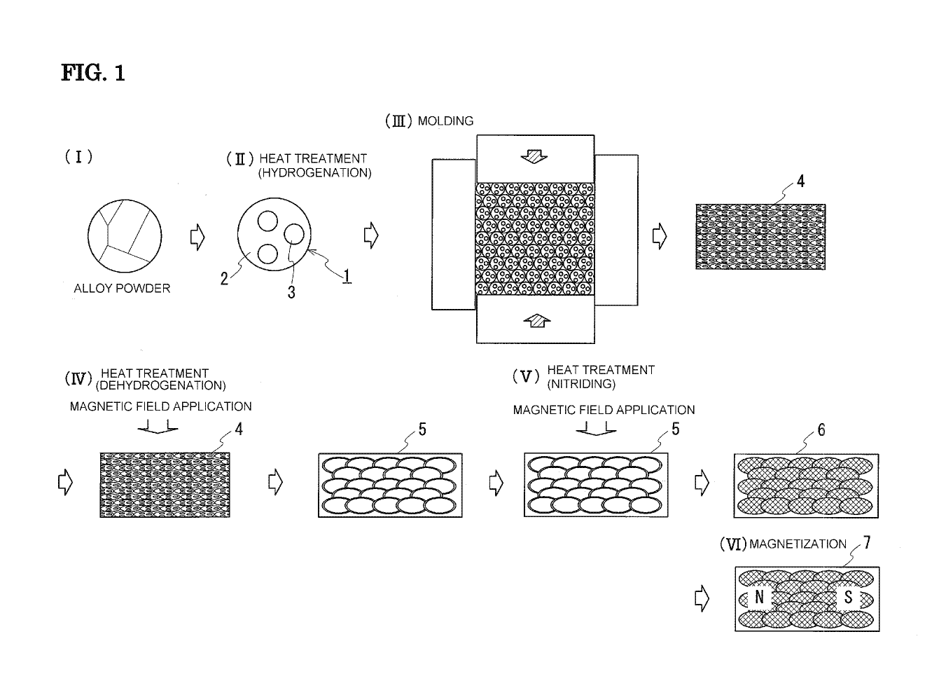

An embodiment of the present invention is described in further detail below by way of test examples. Description is appropriately made with reference to the drawing. In FIG. 1, a hydrogen compound of a rare earth element and alloy particles are exaggerated in order to make the figure easy to understand.

### Test Example 1

A rare earth-iron-based alloy material was prepared, and the resultant rare earth-iron-based alloy material was nitrided to produce a rare earth-iron-nitrogen-based alloy material. A rare earth magnet was formed by using the resultant rare earth-iron-nitrogen-based alloy material and examined with respect to magnetic characteristics. In this test, the influence of a magnetic field for producing the rare earth-iron-based alloy material was examined.

The rare earth-iron-nitrogen-based alloy material was prepared according to the procedures including a preparation step of preparing a multi-phase powder, a molding step of molding a powder compact, a dehydrogenation step of forming a rare earth-iron-based alloy, and a nitriding step.

An alloy ingot of Sm₂Fe₁₇ having an Sm/Fe atomic ratio (at %) of Sm:Fe≠10:90 was prepared, and the alloy ingot was ground by a cemented carbide mortar in an Ar atmosphere to produce an alloy powder (FIG. 1(I)) having an average particle diameter of 100 μm. The average particle diameter was measured at 50% of accumulated weight percentage (particle diameter at 50%) with a laser diffraction-type grain size distribution analyzer.

The alloy powder (starting alloy powder) was heat-treated (hydrogenated) in a hydrogen (H₂) atmosphere at 800° C. for 3 hours. Then, the powder produced by the heat treatment (hydrogenation) was fixed with an epoxy resin to prepare a sample for structure observation. The sample was cut or polished at a desired position so as to avoid oxidation of the powder contained in the sample, and the composition of each of the particles constituting the powder present in the cut surface (or the polished surface) was measured using an energy-dispersive X-ray diffraction (EDX) apparatus. In addition, the cut surface (or the polished surface) was observed with an optical microscope or a scattering electron microscope SEM (100 times to 10,000 times) to examine the form of each of the particles constituting the powder. As a result, it was confirmed that the powder produced by the heat treatment (hydrogenation) has a structure including a plurality of phases (the powder referred to as the “multi-phase powder” hereinafter). Specifically, it was confirmed that as shown in FIG. 1(II), the multi-phase powder is composed of multi-phase particles 1 each including a phase 2 of an iron-containing material (here a Fe phase), which serves as a mother phase, and a plurality of granular phases 3 of a hydrogen compound (SmH₂) of a rare earth element, which are dispersedly present in the mother phase, and the phase 2 of the iron-containing material is interposed between the adjacent particles of the hydrogen compound of a rare earth element.

The contents (% by volume) of the rare earth-iron element hydrogen compound SmH₂ and the iron-containing material (Fe) of each of the multi-phase particles were determined using the sample formed by combining with the epoxy resin. The contents were each determined by calculating a volume ratio using the composition of the starting alloy powder used as a raw material and the atomic weights of SmH₂ and Fe on the assumption of a case where a silicone resin described below was present at a predetermined volume ratio (0.75% by volume). As a result, the content of the hydrogen compound of the rare earth element was 26.8% by volume, and the content of the iron-containing material was 72.6% by volume. In addition, each of the contents of the hydrogen compound of the rare earth element and the iron-containing material was an estimated value calculated by rounding off to one decimal point. Alternatively, each of the contents can be determined by, for example, calculating a volume ratio from an area ratio determined by the area ratios of SmH₂ and Fe in the area of the cut surface (or the polished surface) of the sample, or by using a peak intensity ratio (integrated intensity ratio of peak area) according to X-ray analysis.

Further, the distance between the adjacent particles (=distance between the phases) of the hydrogen compound of the rare earth element was measured by surface analysis (mapping data) of the composition of the multi-phase powder using the EDX apparatus. In this case, peak positions of SmH₂ were extracted in the surface analysis of the cut surface (or the polished surface), and the all distances between the adjacent SmH₂ peak positions were measured and averaged to determine an average value as the distance between the phases (the above-described center-to-center distance). As a result, the distance was 2.4 μm. The distance between the phases can be measured by etching the cut surface (or the polished surface) to extract the phase of the iron-containing material or the phase of the hydrogen compound of the rare earth element.

Each of the multi-phase particles was coated, as an insulating coating, with the silicone resin which became a precursor of a Si—O film to prepare a multi-phase powder having the insulating coating (not shown). The prepared multi-phase powder was compression-molded with a hydraulic press (FIG. 1(III)). Consequently, the powder could be sufficiently compressed under a surface pressure of 10 ton/cm² to form a columnar powder compact 4 having an outer diameter of 10 mm and a height of 10 mm. The molding direction (compression direction) during compression molding was the height direction of the cylinder.

The actual density (molding density) and relative density (ratio of the actual density to the true density) of the resultant powder compact were determined. The actual density was measured by using a commercial density measuring apparatus. The true density was determined by calculation using the density of SmH₂ of 6.51 g/cm³, the density of Fe of 7.874 g/cm³, the density of the silicone resin of 1.1 g/cm³, and the volume ratios described above. As a result, the true density was 7.47 g/cm³, the molding density was 6.89 g/cm³, and the relative density was 92.2%.

The resultant powder compact was heated to 900° C. in a hydrogen atmosphere, and when reached to 900° C., the hydrogen atmosphere was changed to reduced-pressure vacuum (VAC) (final vacuum degree: 1.0 Pa) in which the powder compact was heat-treated (dehydrogenated) under reduced pressure at 900° C. for 10 minutes while the magnetic field (T) shown in Table I was appropriately applied. Since heating was performed in the hydrogen atmosphere, dehydrogenation reaction can be started after the temperature becomes sufficiently high, thereby suppressing reaction defects. The heat treatment (dehydrogenation) was performed while the magnetic field (T) shown in Table I was applied. The magnetic field was applied using a high-temperature superconducting magnet. The direction in which the magnetic field was applied was the same as the direction (here, the height direction of the cylinder) in which the powder compact was molded. Sample No. 100 was heat-treated (dehydrogenated) without the magnetic field applied.

The composition of the compact produced after the heat treatment (dehydrogenation) was examined by the EDX apparatus. As a result, the compact included a rare earth-ion-based alloy material 5 (Fig. I(IV)) composed of a plurality of alloy particles each having a main phase (85% by volume or more) substantially composed of a rare earth-iron-based alloy Sm₂Fe₁₇. Thus, it was found that hydrogen is removed by the heat treatment (dehydrogenation).

At least one of a pair of circular surfaces (planes pressurized in contact with a pressure punch during compression molding) possessed by the cylindrical compact produced after the heat treatment (dehydrogenation) was used as a measurement plane, and the maximum peak intensity Imax and the c-axis peak intensity were measured by X-ray diffraction at the measurement plane to determine the ratio of the c-axis peak intensity to the maximum peak intensity. In this measurement, the integrated intensity I₍₀₀₆₎ at the (006) plane was regarded as the c-axis peak intensity, and the ratio I₍₀₀₆₎/Imax of the peak intensity was determined The results are shown in Table I. The measurement plane corresponded to a plane having a normal line in the direction in which the magnetic field was applied.

TABLE I

| | | | | | | | Rare |
|---|---|---|---|---|---|---|---|
| | | | | | | | earth- |
| | | | | | | | iron- |
| | | | Silicone | | Distance | | based |
| | SmH₂ | Fe (% | resin (% | Relative | between | Magnetic | alloy |
| Sample | (% by | by | by | density | phases | field applied | material |
| No. | volume) | volume) | volume) | (%) | (μm) | during dehydrogenation | I₍₀₀₆₎/Imax |
| 100 | 26.8 | 72.6 | 0.75 | 92.2 | 2.4 | 0.0 | 0.31 |
| 110 | 26.8 | 72.6 | 0.75 | 92.2 | 2.4 | 1.0 | 0.33 |
| 120 | 26.8 | 72.6 | 0.75 | 92.2 | 2.4 | 2.0 | 0.34 |
| 130 | 26.8 | 72.6 | 0.75 | 92.2 | 2.4 | 2.8 | 0.43 |
| 1-1 | 26.8 | 72.6 | 0.75 | 92.2 | 2.4 | 3.0 | 0.83 |
| 1-2 | 26.8 | 72.6 | 0.75 | 92.2 | 2.4 | 3.2 | 1.00 |
| 1-3 | 26.8 | 72.6 | 0.75 | 92.2 | 2.4 | 4.0 | 1.00 |
| 1-4 | 26.8 | 72.6 | 0.75 | 92.2 | 2.4 | 5.0 | 1.00 |

Table I indicates that when the magnetic field is applied in the dehydrogenation step, the crystal grains composed of the rare earth-iron-based alloy are easily oriented in the c-axis direction. It is found that in particular, when the strong magnetic field of 3 T or more is applied, the rare earth-iron-based alloy material having a structure with orientation in the c-axis direction, more specifically, satisfying I₍₀₀₆₎/Imax≧0.83 or more and further I₍₀₀₆₎/Imax=1, is produced.

Each of the resultant rare earth-iron-based alloy materials was heat treated (nitrided) in a nitrogen (N₂) atmosphere at 425° C. for 3 hours. As a result of examination with an EDX apparatus for the composition of the cylindrical compact produced after the heat treatment (nitriding), it was found that the compact includes a rare earth-iron-nitrogen-based alloy material 6 (FIG. 1(V)) composed of a rare earth-iron-nitrogen-based alloy such as a Sm—Fe—N alloy, and a nitride is formed by the heat treatment (nitriding).

Each of the rare earth-iron-nitrogen-based alloy materials produced by the heat treatment (nitriding) was magnetized by a pulsed magnetic field of 2.4 MA/m (=30 kOe), and then the magnet characteristics of each of the resultant samples (rare earth magnet 7 (FIG. 1(VI) composed of the rare earth-iron-nitrogen-based alloy) were examined using a BH tracer (DCBH tracer manufactured by Riken Denshi Co., Ltd.). The results are shown in Table II. In this case, as the magnetic characteristics, saturation magnetic flux density Bs (T), residual magnetic flux density Br (T), intrinsic coercive force iHc (kA/m), and the maximum product (BH)max (kJ/m³) of magnetic flux density B and magnitude H of demagnetizing field were determined. These magnetic characteristics were determined in the direction in which the magnetic field was applied, i.e., the direction (height direction of the cylinder) in which the powder compact was molded. In addition, like for the rare earth-iron-based alloy material, for each of the samples including the cylindrical compact, at least one of a pair of circular surfaces (planes) possessed by the sample was used as a measurement plane, and the maximum peak intensity Imax and the c-axis peak intensity were measured by X-ray diffraction at the measurement plane to determine the ratio of the c-axis peak intensity to the maximum peak intensity. In this measurement, the integrated intensity I₍₀₀₆₎ at the (006) plane was regarded as the c-axis peak intensity, and the ratio I₍₀₀₆₎/Imax of the peak intensity was determined. The results are shown in Table II. The measurement plane corresponded to a plane having a normal line in the direction in which the magnetic field was applied.

TABLE II

| | Magnetic | Rare earth- | | | | | |
|---|---|---|---|---|---|---|---|
| | field applied | iron-based | Rare earth-iron-nitrogen-based alloy material | | | | |
| Sample | during | alloy material | Bs | Br | iHc | (BH)max | |
| No. | dehydrogenation (T) | I₍₀₀₆₎/Imax | (T) | (T) | (kA/m) | (kJ/m³) | I₍₀₀₆)/Imax |
| 100 | 0.0 | 0.31 | 1.46 | 0.92 | 820 | 168 | 0.30 |
| 110 | 1.0 | 0.33 | 1.46 | 0.93 | 820 | 170 | 0.32 |
| 120 | 2.0 | 0.34 | 1.45 | 0.91 | 800 | 164 | 0.34 |
| 130 | 2.8 | 0.43 | 1.43 | 0.97 | 860 | 180 | 0.44 |
| 1-1 | 3.0 | 0.83 | 1.40 | 1.26 | 910 | 254 | 0.86 |
| 1-2 | 3.2 | 1.00 | 1.38 | 1.31 | 960 | 269 | 1.00 |
| 1-3 | 4.0 | 1.00 | 1.36 | 1.30 | 950 | 266 | 1.00 |
| 1-4 | 5.0 | 1.00 | 1.33 | 1.28 | 960 | 262 | 1.00 |

Table II indicates that when the rare earth-iron-based alloy material having a specified oriented structure (here, a c-axis oriented structure satisfying I₍₀₀₆₎/Imax≧0.83) is nitrided, the resultant rare earth-iron-nitrogen-based alloy material has the same oriented structure (a c-axis oriented structure satisfying I₍₀₀₆₎/Imax≧0.83). In other words, it is found that the oriented structure of the rare earth-iron-based alloy material used as the raw material is substantially maintained. In addition, it is found that the rare earth magnet using the rare earth-iron-nitrogen-based alloy material satisfying I₍₀₀₆₎/Imax≧0.83 as the raw material has higher coercive force and excellent magnetic characteristics as compared with a case using a rare earth-iron-nitrogen-based alloy material satisfying I₍₀₀₆₎/Imax<0.83.

### Test Example 2

A rare earth-iron-based alloy material was prepared by the same method as for Sample No. 1-2 of Test Example 1, and the resultant rare earth-iron-based alloy material was nitrided to produce a rare earth-iron-nitrogen-based alloy material. A rare earth magnet was formed and examined with respect to magnetic characteristics by the same method as in Test Example 1. In this test, the influence of the magnetic field during nitriding was examined.

As described above, the prepared rare earth-iron-based alloy material included a compact including a plurality of alloy particles each substantially composed of a rare earth-iron-based alloy of Sm₂Fe₁₇ and satisfied I₍₀₀₆₎/Imax=1.0 (magnetic field applied during heat treatment (dehydrogenation): 3.2 T, direction of the magnetic field applied: the same as the molding direction during compression molding, a cylinder having an outer diameter of 10 mm and a height of 10 mm) The rare earth-iron-based alloy material was heat-treated (nitrided) in a nitrogen (N₂) atmosphere at 425° C. for 3 hours. The heat treatment (nitriding) was performed while the magnetic field (T) shown in Table III was applied (FIG. 1(V)). The magnetic field was applied using a high-temperature superconducting magnet. The direction in which the magnetic field was applied was the same as the direction in which the magnetic field was applied in the dehydrogenation step (=molding direction of the powder compact=height direction of the cylinder). Sample No. 2-1 was heat-treated (nitrided) without the magnetic field applied.

As a result of examination with the EDX apparatus for the composition of each of the compacts produced after the heat treatment (nitriding), it was found that the compact includes a rare earth-iron-nitrogen-based alloy material 6 (FIG. 1(V)) composed of a rare earth-iron-nitrogen-based alloy such as a Sm—Fe—N alloy, and a nitride is formed by the heat treatment (nitriding).

The magnetic characteristics of each of the samples (rare earth magnet 7 (FIG. 1(VI) composed of the rare earth-iron-nitrogen-based alloy) produced by magnetizing, under the same conditions as in Test Example 1, the rare earth-iron-nitrogen-based alloy materials produced by the heat treatment (nitriding) were examined by the same method as in Test Example 1. The results are shown in Table III. In addition, like in Test Example 1, at least one of a pair of circular surfaces (planes) possessed by each of the samples including the cylindrical compact was used as a measurement plane, and the maximum peak intensity Imax at the measurement plane and the integrated intensity I₍₀₀₆₎ at the (006) plane were measured to determine the ratio I₍₀₀₆₎/Imax of the peak intensity. The results are shown in Table III. The measurement plane corresponded to a plane having a normal line in the direction in which the magnetic field was applied.

TABLE III

| | | Rare earth- | | | | | | |
|---|---|---|---|---|---|---|---|---|
| | Magnetic | iron-based | Magnetic | | | | | |
| | field applied | alloy | field applied | Rare earth-iron-nitrogen-based alloy material | | | | |
| Sample | during | material | during | Bs | Br | iHc | (BH)max | |
| No. | dehydrogenation (T) | I₍₀₀₆₎/Imax | nitriding (T) | (T) | (T) | (kA/m) | (kJ/m³) | I₍₀₀₆₎/Imax |
| 2-1 | 3.2 | 1.00 | 0.0 | 1.38 | 1.31 | 960 | 269 | 1.00 |
| 2-2 | 3.2 | 1.00 | 1.0 | 1.37 | 1.31 | 950 | 260 | 1.00 |
| 2-3 | 3.2 | 1.00 | 2.0 | 1.40 | 1.32 | 950 | 265 | 1.00 |
| 2-4 | 3.2 | 1.00 | 3.0 | 1.39 | 1.29 | 980 | 260 | 1.00 |
| 2-5 | 3.2 | 1.00 | 3.3 | 1.42 | 1.33 | 970 | 274 | 1.00 |
| 2-6 | 3.2 | 1.00 | 3.5 | 1.45 | 1.37 | 1030 | 297 | 1.00 |
| 2-7 | 3.2 | 1.00 | 3.7 | 1.46 | 1.38 | 1040 | 301 | 1.00 |
| 2-8 | 3.2 | 1.00 | 4.0 | 1.47 | 1.40 | 1030 | 303 | 1.00 |
| 2-9 | 3.2 | 1.00 | 5.0 | 1.46 | 1.41 | 1060 | 308 | 1.00 |

Table III indicates that like in Test Example 1, when the rare earth-iron-based alloy material having a specified oriented structure (here, a c-axis oriented structure satisfying I₍₀₀₆₎/Imax≧0.83) is nitrided, the resultant rare earth-iron-nitrogen-based alloy material has the same oriented structure (a c-axis oriented structure satisfying I₍₀₀₆₎/Imax≧0.83). In particular, it is found that the rare earth magnet using, as the raw material, the rare earth-iron-nitrogen-based alloy material produced by applying the strong magnetic field of 3.5 T or more during the heat treatment (nitriding) has higher coercive force and excellent magnetic characteristics as compared with a rare earth magnet produced without a magnetic field applied or a magnetic field of less than 3.5 T applied during the heat treatment (nitriding). The reason for this is considered to be the fact that the rare earth-iron-nitrogen-based alloy (here, the Sm—Fe—N alloy) easily becomes an alloy with an ideal atomic ratio, i.e., Sm₂Fe₁₇N₃, by applying the strong magnetic field of 3.5 T or more during the heat treatment (nitriding). Also, it is considered that since the direction in which the magnetic field is applied during the heat treatment (nitriding) is the same as that during the heat treatment (dehydrogenation), an alloy with an ideal atomic ratio can be more easily formed. In fact, as a result of examination of the composition of Sample No. 2-7, the sample was substantially composed of Sm₂Fe₁₇N₃.

The above-described Test Examples 1 and 2 reveal that when the powder compact made of an alloy powder having a structure in which the phase of the hydrogen compound of the rare earth element is dispersedly present in the iron-containing material is heat-treated (dehydrogenated) while a strong magnetic field of 3 T or more is applied, and the rare earth-iron-based alloy material produced after the heat treatment (dehydrogenation) is heat-treated (nitrided) while a strong magnetic field of 3.5 T or more is applied, a rare earth magnet having excellent magnetic characteristics can be formed.

### Test Example 3

A rare earth magnet was formed and examined with respect to magnetic characteristics by the same method as in Test Example 2. In this test, a powder composed of Sm₁Fe₁₁Ti₁ was used as a rare earth-iron-based alloy powder (starting alloy powder) used as a starting material.

In this test, a Sm₁Fe₁₁Ti₁ alloy powder (FIG. 1(I)) having an average particle diameter of 100 μm was produced by a gas atomization method (Ar atmosphere). The average particle diameter was measured by the same method as in Test Example 1. In this test, the alloy powder including particles each composed of a polycrystal was formed by the gas atomization method.

The alloy powder (starting alloy powder) was heat-treated (hydrogenated) in a hydrogen (H₂) atmosphere at 800° C. for 1 hour. The form of the powder produced by the heat treatment (hydrogenation) was examined by the same method as in Test Example 1. As a result, it was confirmed that as shown in FIG. 1(II), the powder is composed of multi-phase particles 1 each including a phase 2 of an iron-containing material (here Fe and a FeTi compound), which serves as a mother phase, and a plurality of granular phases 3 of a hydrogen compound (SmH₂) of a rare earth element, which are dispersedly present in the mother phase, and the phase 2 of the iron-containing material is interposed between the adjacent particles of the hydrogen compound of a rare earth element.

The distance between the adjacent particles (distance between the phases) of the hydrogen compound of the rare earth element in each of the multi-phase particles was measured by the same method as in Test Example 1. As a result, the distance was 2.3 μm. Further, as a result of determination of the contents (% by volume) of the hydrogen compound (SmH₂) of the rare earth element and the iron-containing material (Fe and a FeTi compound) of each of the multi-phase particles by the same method as in Test Example 1, the content of the hydrogen compound of the rare earth element was 22% by volume, and the content of the iron-containing material was 77% by volume.

An insulating coating composed of the silicone resin was formed on each of the multi-phase particles to prepare a multi-phase powder having the insulating coating by the same method as in Test Example 1. The prepared multi-phase powder was compression-molded with a hydraulic press (FIG. 1(III)). Consequently, the powder could be sufficiently compressed under a surface pressure of 10 ton/cm² to form a cylindrical powder compact 4 having an outer diameter of 10 mm and a height of 10 mm. The molding direction (compression direction) during compression molding was the same as the height direction of the cylinder.

The relative density of the resultant powder compact was determined by the same method as in Test Example 1. As a result, the relative density was 93% (content of the silicone resin: 0.75% by volume). This reveals that like in Test Example 1, a powder compact having a complicated shape and a high-density powder compact having a relative density of 90% or more can be produced even by using the multi-phase powder produced in Test Example 3. In particular, in Test Example 3, the content of the iron-containing material is 77% by volume, and the ratio of the iron-containing component having excellent moldability is higher than that of the configuration (content of the iron-containing material: 72.6% by volume) not containing Ti formed in Test Example 1, thereby causing excellent moldability. Thus, as described above, a powder compact having a high density can be precisely formed.

The resultant powder compact was heated to 825° C. in a hydrogen atmosphere, and when reached to 825° C., the hydrogen atmosphere was changed to reduced-pressure vacuum (VAC) (final vacuum degree: 1.0 Pa) in which the powder compact was heat-treated (dehydrogenated) at 825° C. for 10 minutes while the magnetic field (T) shown in Table IV was appropriately applied (FIG. 1(IV)). In this test, the heat treatment (dehydrogenation) was performed while the magnetic field (T) shown in Table IV was applied. The magnetic field was applied using a high-temperature superconducting magnet. The direction in which the magnetic field was applied was the same as the direction (here, the height direction of the cylinder) in which the powder compact was molded. Sample No. 300 was heat-treated (dehydrogenated) without the magnetic field applied.

The composition of the compact produced after the heat treatment (dehydrogenation) was examined by the EDX apparatus. As a result, the compact includes a rare earth-ion-based alloy material 5(Fig. I(IV)) composed of a plurality of alloy particles each including a main phase (92% by volume or more) composed of a rare earth-iron-based alloy Sm₁Fe₁₁Ti₁. Thus, it was found that hydrogen is removed by the heat treatment (dehydrogenation).

In addition, like in Test Example 1, a circular surface (plane) possessed by the cylindrical compact produced after the heat treatment (dehydrogenation) was used as a measurement plane, and the maximum peak intensity Imax at the measurement plane and the integrated intensity I₍₀₀₂₎ at a (002) plane as the peak intensity in the c-axis were measured to determine the ratio I₍₀₀₂₎/Imax of the peak intensity. The results are shown in Table IV. The measurement plane corresponded to a plane having a normal line in the direction in which the magnetic field was applied.

Each of the resultant rare earth-iron-based alloy materials was heat treated (nitrided) in a nitrogen (N₂) atmosphere at 425° C. for 180 minutes. The heat treatment (nitriding) was performed while the magnetic field (T) shown in Table IV was applied (FIG. 1(V)). The magnetic field was applied using a high-temperature superconducting magnet. The direction in which the magnetic field was applied was the same as the direction in which the magnetic field was applied in the dehydrogenation step (=molding direction of the powder compact=height direction of the cylinder). Sample Nos. 300 to 330, 3-1. 3-2, 3-11, and 3-12 were heat-treated (nitrided) without the magnetic field applied.

As a result of examination with an EDX apparatus for the composition of the compact produced after the heat treatment (nitriding), it was found that the compact includes a rare earth-iron-nitrogen-based alloy material 6 (FIG. 1(V)) composed of a rare earth-iron-nitrogen-based alloy such as a Sm—Fe—Ti—N alloy, and a nitride is formed by the heat treatment (nitriding).

The magnetic characteristics of each of the samples (rare earth magnet 7 (FIG. 1(VI) composed of the rare earth-iron-nitrogen-based alloy) produced by magnetizing, under the same conditions as in Test Example 1, the rare earth-iron-nitrogen-based alloy materials produced by the heat treatment (nitriding) were examined by the same method as in Test Example 1. The results are shown in Table IV. In addition, like in Test Example 1, for each of the samples including the cylindrical compact, at least one of a pair of circular surfaces (planes) possessed by the sample was used as a measurement plane, and the maximum peak intensity Imax at the measurement plane and the integrated intensity I₍₀₀₂₎ at the (002) plane were measured to determine the ratio I₍₀₀₂₎/Imax of the peak intensity in the same manner as for the rare earth-iron-based alloy. The results are shown in Table IV. The measurement plane corresponded to a plane having a normal line in the direction in which the magnetic field was applied.

TABLE IV

| | | | Magnetic | | | | | |
|---|---|---|---|---|---|---|---|---|
| | | Rare earth- | field | | | | | |
| | Magnetic | iron-based | applied | | | | | |
| | field applied | alloy | during | Rare earth-iron-nitrogen-based alloy material | | | | |
| Sample | during | material | nitriding | Bs | Br | iHc | (BH)max | |
| No. | dehydrogenation (T) | I₍₀₀₂₎/Imax | (T) | (T) | (T) | (kA/m) | (kJ/m³) | I₍₀₀₂₎/Imax |
| 300 | 0.0 | 0.18 | 0 | 1.08 | 0.76 | 610 | 108 | 0.18 |
| 310 | 1.0 | 0.17 | 0 | 1.08 | 0.76 | 610 | 106 | 0.17 |
| 320 | 2.0 | 0.17 | 0 | 1.09 | 0.75 | 620 | 103 | 0.18 |
| 330 | 2.8 | 0.38 | 0 | 1.06 | 0.79 | 640 | 112 | 0.39 |
| 3-1 | 3.0 | 0.84 | 0 | 1.05 | 0.86 | 660 | 132 | 0.86 |
| 3-2 | 3.2 | 1.00 | 0 | 1.05 | 0.92 | 660 | 142 | 1.00 |
| 3-3 | 3.2 | 1.00 | 1.0 | 1.06 | 0.93 | 680 | 148 | 1.00 |
| 3-4 | 3.2 | 1.00 | 2.0 | 1.06 | 0.94 | 670 | 147 | 1.00 |
| 3-5 | 3.2 | 1.00 | 3.0 | 1.08 | 0.94 | 680 | 149 | 1.00 |
| 3-6 | 3.2 | 1.00 | 3.3 | 1.09 | 0.94 | 680 | 150 | 1.00 |
| 3-7 | 3.2 | 1.00 | 3.5 | 1.11 | 0.99 | 710 | 153 | 1.00 |
| 3-8 | 3.2 | 1.00 | 3.7 | 1.13 | 1.04 | 740 | 165 | 1.00 |
| 3-9 | 3.2 | 1.00 | 4.0 | 1.14 | 1.05 | 750 | 168 | 1.00 |
| 3-10 | 3.2 | 1.00 | 5.0 | 1.13 | 1.05 | 760 | 170 | 1.00 |
| 3-11 | 4.0 | 1.00 | 0 | 1.02 | 0.92 | 660 | 140 | 1.00 |
| 3-12 | 5.0 | 1.00 | 0 | 1.01 | 0.93 | 670 | 145 | 1.00 |

Table IV indicates that like in Test Example 1, when the rare earth-iron-based alloy material composed of a rare earth-iron-based alloy such as a Sm—Fe—Ti alloy and having a specified oriented structure (here, a c-axis oriented structure satisfying I₍₀₀₂₎/Imax≧0.83) is nitrided, a rare earth-iron-nitrogen-based alloy material composed of a rare earth-iron-nitrogen-based alloy such as a Sm—Fe—Ti—N alloy and having the same oriented structure (a c-axis oriented structure satisfying I₍₀₀₂₎/Imax≧0.83) is produced. In particular, it is found that even if the amount of the rare earth element used is decreased, a rare earth magnet having excellent magnetic characteristics can be formed by applying the strong magnetic field of 3 T or more during the heat treatment (dehydrogenation) and applying the strong magnetic field of 3.5 T or more during the heat treatment (nitriding) as in Test Example 2. Like in Test Example 2, the reason for this is considered to be that an alloy with an ideal atomic ratio, i.e., Sm₁Fe₁₁Ti₁N₁, can be easily formed. In fact, as a result of examination of the composition of Sample No. 3-9, the sample was substantially composed of Sm₁Fe₁₁Ti₁N₁. In sample Nos. 3-11 and 3-12, it can be expected that a rare earth magnet having further excellent magnetic characteristics can be produced by applying a magnetic field during heat treatment (nitriding) in addition to during heat treatment (dehydrogenation).

In addition, the present invention is not limited to the above-described embodiments, and appropriate changes can be made without deviating from the gist of the present invention. For example, the composition and average particle diameter of the starting alloy powder, the composition and distance between the phases of the multi-phase powder, the material of the insulating coating, the presence of the antioxidant layer, the shape, size, and relative density of the powder compact, the molding pressure during compression molding, various heat treatment conditions (atmosphere, temperature, retention time, and applied magnetic field), etc. can be appropriately changed.

### INDUSTRIAL APPLICABILITY

A rare earth-iron-nitrogen-based alloy material of the present invention can be preferably used for raw materials of permanent magnets used for various motors, particularly high-speed motors provided in a hybrid electric vehicle (HEV) and a hard disk drive (HDD). A rare earth-iron-based alloy material of the present invention can be preferably used as a raw material of the rare earth-iron-nitrogen-based alloy material of the present invention. A method for producing a rare earth-iron-based alloy material of the present invention and a method for producing a rare earth-iron-nitrogen-based alloy material of the present invention can be preferably used for producing the rare earth-iron-based alloy material of the present invention and the rare earth-iron-nitrogen-based alloy material of the present invention, respectively.

### REFERENCE SIGNS LIST

1 multi-phase particle
2 phase of iron-containing material
3 phase of hydrogen compound of rare earth element
4 powder compact
5 rare earth-iron-based alloy material
6 rare earth-iron-nitrogen-based alloy material
7 rare earth magnet

1.-10. (canceled)

11. A rare earth-iron-based alloy material used for a raw material of a rare earth magnet, the alloy material comprising a compact composed of a plurality of alloy particles which are composed of a rare earth-iron-based alloy containing a rare earth element,
wherein I(a, b, c)/Imax≧0.83 is satisfied, where when any desired plane constituting the outer surface of the compact or any desired section of the compact is used as a measurement plane, Imax is a maximum X-ray diffraction peak intensity at the measurement plane, I(a, b, c) is an X-ray diffraction peak intensity along an axis of a crystal lattice constituting the alloy particles present in the measurement plane, and I(a, b, c)/Imax is a ratio of the peak intensity along the axis to the maximum peak intensity.

12. A rare earth-iron-nitrogen-based alloy material used for a raw material of a rare earth magnet, the alloy material comprising a compact composed of a plurality of alloy particles which are composed of a rare earth-iron-nitrogen-based alloy containing a rare earth element,
wherein I(a, b, c)/Imax≧0.83 is satisfied, where when any desired plane constituting the outer surface of the compact or any desired section of the compact is used as a measurement plane, Imax is a maximum X-ray diffraction peak intensity at the measurement plane, I(a, b, c) is an X-ray diffraction peak intensity along an axis of a crystal lattice constituting the alloy particles present in the measurement plane, and I(a, b, c)/Imax is a ratio of the peak intensity along the axis to the maximum peak intensity.

13. The rare earth-iron-nitrogen-based alloy material according to claim 12, wherein Ic/Imax≧0.83 is satisfied, where Ic is an X-ray diffraction peak intensity along a c-axis of the crystal lattice.

14. The rare earth-iron-nitrogen-based alloy material according to claim 12, wherein the rare earth element is Sm.

15. The rare earth-iron-nitrogen-based alloy material according to claim 12, wherein the alloy contains Sm and Ti.

16. A method for producing a rare earth-iron-based alloy material used for a raw material of a rare earth magnet, the method comprising:
a preparation step of heat-treating a rare earth-iron-based alloy powder containing a rare earth element in an atmosphere containing a hydrogen element at a temperature equal to or higher than a disproportionation temperature of the rare earth-iron-based alloy to prepare a multi-phase powder composed of a multi-phase particle in which a phase of a hydrogen compound of the rare earth element is dispersedly present in a phase of an iron-containing material containing Fe, and the content of the phase of the hydrogen compound of the rare earth element is 40% by volume or less;
a molding step of forming a powder compact by compression-molding the multi-phase powder; and
a dehydrogenation step of heat-treating the powder compact in an inert atmosphere or a reduced-pressure atmosphere at a temperature equal to or higher than a recombination temperature of the powder compact to form a rare earth-iron-based alloy material,
wherein the heat treatment in the dehydrogenation step is performed by applying a magnetic field of 3 T or more to the powder compact.

17. The method for producing a rare earth-iron-based alloy material according to claim 16, wherein the magnetic field is applied using a high-temperature superconducting magnet.

18. A method for producing a rare earth-iron-nitrogen-based alloy material used for a raw material of a rare earth magnet, the method comprising:
a preparation step of heat-treating a rare earth-iron-based alloy powder containing a rare earth element in an atmosphere containing a hydrogen element at a temperature equal to or higher than a disproportionation temperature of the rare earth-iron-based alloy to prepare a multi-phase powder composed of a multi-phase particle in which a phase of a hydrogen compound of the rare earth element is dispersedly present in a phase of an iron-containing material containing Fe, and the content of the phase of the hydrogen compound of the rare earth element is 40% by volume or less;
a molding step of forming a powder compact by compression-molding the multi-phase powder;
a dehydrogenation step of heat-treating the powder compact in an inert atmosphere or a reduced-pressure atmosphere at a temperature equal to or higher than a recombination temperature of the powder compact to form a rare earth-iron-based alloy material; and
a nitriding step of heat-treating the rare earth-iron-based alloy material in an atmosphere containing a nitrogen element at a temperature equal to or higher than a nitriding temperature and equal to or lower than a nitrogen disproportionation temperature of the rare earth-iron-based alloy material to form a rare earth-iron-nitrogen-based alloy material,
wherein the heat treatment in the dehydrogenation step is performed by applying a magnetic field of 3 T or more to the powder compact; and
the heat treatment in the nitriding step is performed by applying a magnetic field of 3.5 T or more to the rare earth-iron-based alloy material.

19. The method for producing a rare earth-iron-nitrogen-based alloy material according to claim 18, wherein a direction in which the magnetic field is applied in the nitriding step is the same as a direction in which the magnetic field is applied in the dehydrogenation step.

20. The method for producing a rare earth-iron-nitrogen-based alloy material according to claim 18, wherein in the dehydrogenation step and the nitriding step, the magnetic field is applied using a high-temperature superconducting magnet.
